(19) United States
(12) Patent Application Publication
(10) Pub. No.: US 2016/0110038 A1
(43) Pub. Date: Apr. 21, 2016

(54) MENU SYSTEM AND INTERACTIONS WITH AN ELECTRONIC DEVICE

(71) Applicant: Intel Corporation, Santa Clara, CA (US)

(72) Inventors: Glen J. Anderson, Beaverton, OR (US); Jose K. Sia, JR., Hillsboro, OR (US); Lenitra M. Durham, Beaverton, OR (US); Jared S. Bauer, Seattle, WA (US)

(21) Appl. No.: 14/978,525

(22) Filed: Dec. 22, 2015

Related U.S. Application Data
(63) Continuation of application No. 13/992,915, filed on Jun. 10, 2013.

(51) Int. Cl. G06F 3/0482; G06F 3/01; G06F 3/0484; G06F 3/0481

(52) U.S. Cl. CPC G06F 3/0482; G06F 3/04817; G06F 3/017; G06F 3/04842

(57) ABSTRACT

An electronic device includes a controller that is configured to execute an iconic menu system. A display is coupled to the controller and configured to display icons generated by the controller. A plurality of sensors are coupled to the controller and configured to detect a movement of the electronic device. Memory is also coupled to the controller. The controller is further configured to execute a selected one of a plurality of functions in response to the movement, the function being associated with a selected icon of the iconic menu system.

### CLAIM OF PRIORITY

This application is a continuation of U.S. patent application Ser. No. 13/992,915, filed on Jun. 10, 2013, which is a U.S. National Stage Filing under 35 U.S.C. 371 from International Application No. PCT/US2013/030499, filed on Mar. 12, 2013, entitled MENU SYSTEM AND INTERACTIONS WITH AN ELECTRONIC DEVICE, each of which application is incorporated herein by reference in its entirety.

### TECHNICAL FIELD

Embodiments described herein generally relate to interactions with an electronic device.

### BACKGROUND

Wrist-based electronic devices (e.g., smart watches) typically have bulky form factors and are limited to mostly displays. The wrist-based devices that do include a means for inputting data typically use extremely small keypads that can be difficult to activate due to the small size of the buttons.

More recent wrist-based electronic devices have included touch screen input to facilitate entering data and commands. However, these devices are typically limited in functionality and some are even dedicated to a couple functions. For example, global positioning system (GPS) watches can only be used for determining the time and the wearer's location.

### BRIEF DESCRIPTION OF THE DRAWINGS

FIG. 1 shows a diagram of an embodiment of a wearable electronic device.

FIG. 2 shows a block diagram of an embodiment of an electronic system in accordance with the wearable electronic device of FIG. 1.

FIG. 3 shows an embodiment of different menus and submenus displayable on the electronic device.

FIG. 4 shows an embodiment of various possible interactions for navigating through menus of the electronic device.

FIG. 5 shows multiple embodiments of messages that can appear on the display of the electronic device.

FIG. 6 shows an embodiment for generating messages on the electronic device.

FIG. 7 shows an embodiment for interacting with the menu system of the electronic device using gestures.

FIG. 8 shows a flowchart of an embodiment of an iconic menu system interaction.

FIG. 9 shows a flowchart of another embodiment of an iconic menu system interaction.

FIG. 10 shows a flowchart of another embodiment of an iconic menu system interaction.

FIG. 11 shows a flowchart of another embodiment of an iconic menu system interaction.

FIG. 12 shows a flowchart of another embodiment of an iconic menu system, interaction.

FIG. 13 shows a flowchart of another embodiment of an iconic menu system interaction.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments.

Typical prior art wearable electronic devices suffer from limited input ability due to button size and/or a limited number of buttons. Embodiments of a wearable electronic device may provide iconic-based user input and sensor-based input to enable a user to interact with the electronic device. The electronic device may respond to the user and sensor inputs through visual outputs (e.g., LCD, LED), haptic sensations (e.g., vibrations), and aural outputs (e.g., sound). This may provide a user with an extended capability to interact with the wearable electronic device beyond a simple keypad or touchscreen only input.

The subsequent discussion refers to a wristband electronic device. However, one skilled in the art will realize that the present embodiments for iconic menus, sensor-based user interaction, and touch screen-based interaction may be used in other types of electronic devices, wearable or otherwise.

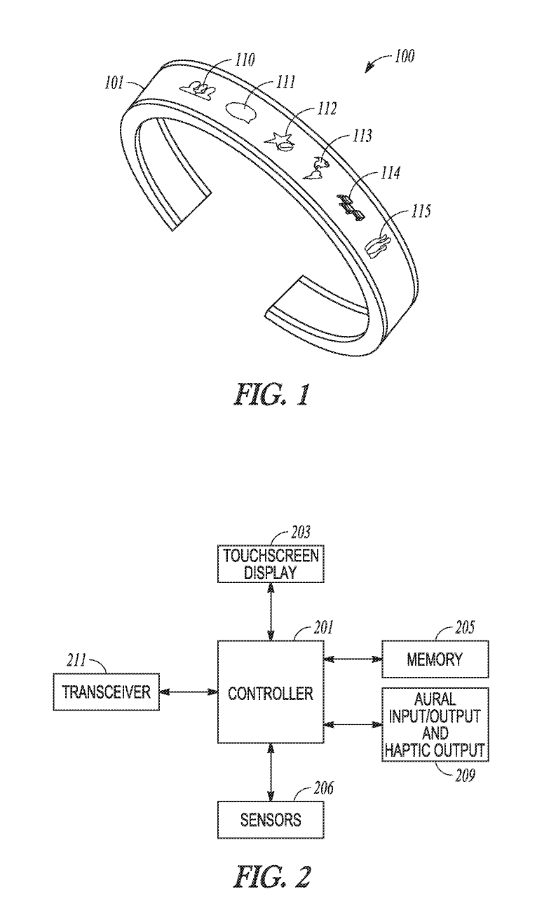

FIG. 1 illustrates a diagram of an embodiment of a wearable electronic device 100. The illustrated embodiment is for a wristband electronic device that includes a touch sensitive input (e.g., touchscreen) 101 that displays a number of icons 110-115.

The touch sensitive input 101 may be any type of touch sensitive display. For example, the touch sensitive input 101 may be a liquid crystal display (LCD), an organic light emitting diode display (OLED), a plasma display, electronic ink (e-ink), or some other type of display that may be used as a touch sensitive display.

The touch sensitive input 101 uses icons 110-115, in combination with the touchscreen capabilities, to enable the user to interact with the electronic device. The icons 110-115 may represent different functions of a menu system of the electronic device. Touching an icon would enable a user to select and initiate a function of the electronic device. The menu/iconic functionality and user interaction will be discussed in greater detail below. The electronic device may also have an area of the touch sensitive input that is away from and adjacent to the icons 110-115 so that the user can touch the area while keeping the display visible.

The wearable electronic device 100 may also include sensors that enable the device to sense a variety of things such as conditions, movement, and current location of the device. For example, the sensors may include a global positioning system (GPS) receiver that enables the device to determine its geographical location. A light sensor provides the device with the capability to adjust its display brightness in response to ambient lighting. An accelerometer and/or solid state gyroscope can enable the device to determine a movement of the user (e.g., movement of the user's arm). A temperature sensor can enable the device to determine an ambient temperature. A barometric sensor can enable the device to determine ambient pressure that may also provide the user with an altitude of the device. The listed sensors are for purposes of illustration only. The electronic device may include additional sensor capability. The device can also connect to other sensors separate and disparate from the body of the device. Other sensors, such as conductance for galvanic skin response, FNIRs to detect blood circulation, and electro-encephalographic (EEG) data for ahead mounted sensor.

The wearable electronic device 100 may operate as a stand-alone device, as a companion to another electronic device (e.g., mobile telephone), or as a hub at the center of an ensemble of devices. In the stand-alone mode, the electronic device would be completely self-contained and would rely solely on its own sensory input, in addition to user input, for operation. The electronic device might still have the capability to communicate with other electronic devices and/or systems, but that capability would be disabled in the stand-alone mode.

In the companion mode, the device would include some type of radio transceiver to communicate with other electronic devices and/or systems. The radio transceiver could communicate using different communication standards. For example, the radio transceiver might be capable of transmitting and receiving over a cellular standard (e.g., global system for mobile (GSM), time division multiple access (TDMA), code division multiple access (CDMA)), WI-FI™, and/or BLUETOOTH™.

In the hub mode, the device would include two radio transceivers. The first radio transceiver would operate like the one specified in the companion mode, and its main role would be to communicate with other computing devices like cell phones and ultrabooks. The second radio transceiver would operate as a central hub for a network of devices. These devices could include a variety of wearable sensors worn on various parts of the body, sensing a variety of inputs. The wearable electronic device would serve as the central data aggregation and processing point for the network.

FIG. 2 illustrates a block diagram of an embodiment of an electronic system in accordance with the wearable electronic device 100 of FIG. 1. This block diagram is for purposes of illustration only as other electronic systems may be used to implement the menu system and user interaction capability of the wearable electronic device 100.

The system may include a controller 201 that is responsible for overall control of the electronic system. The controller 201 may include a microprocessor, such as a reduced instruction set computing (RISC) processor, a complex instruction set computing (CSC) processor, dedicated control circuitry, or some other type of control circuitry. The controller 201 is configured to execute the menu system as described subsequently.

The system may further include memory 205, coupled to the controller 201, for storage of data. The memory 205 may include read only memory (ROM), non-volatile memory (e.g., flash), random access memory (RAM) such as static RAM (SRAM) and dynamic RAM (DRAM), or other types of memory. The memory 205 may be used to store an operating system, to operate with the subsequently described menu system, temporary operating data generated during device operation, or various operating parameters used by the system in combination with the various sensors.

A touchscreen display 203 is coupled to the controller 201 for inputting data to the system for use by the controller or to be stored in memory 205, The touchscreen display 203 is also used by the controller 201 to display the icons and other data generated during system operation.

A sensor block 206 is coupled to the controller 201 for detecting and generating sensory data used by the controller 201 during system operation. The sensor block 206 may include the sensors as described previously in addition to other types of sensors.

An aural input/output (I/O) and haptic output block 209 is coupled to the controller 201 for providing sound I/O and vibration sensations. For example, the aural I/O and haptic output block 209 may include a speaker for sound generation, a microphone to pick up ambient sounds (e.g. voice), and a vibration generation device to generate haptic sensations (e.g., vibrations) for the user.

A radio transceiver 211 is coupled to the controller 201 to provide a radio transmission and receiver capability to the electronic system that enables the system to link to other electronic systems. As described previously, the radio transceiver 211 may be used by the electronic system to communicate over one or more various communication standards while in the companion mode.

The menu system of the electronic device provides the user with an interaction capability using different touch gestures on the touchscreen display. These gestures may include a horizontal sweep for changing menu depth, a vertical sweep for navigation across the same level of menus, and a “hold and sweep” gesture to enable changing of a single icon/item on a particular menu level. The “hold and sweep” gesture may be accomplished, for example, by touching and holding an assigned spot of the touchscreen (e.g., icon) with a thumb while substantially simultaneously sweeping across the display with a finger.

Selection of a particular menu item may be accomplished using one or a combination of different methods. For example, the user may tap an icon on the touchscreen display, push and click a button or portion of the display having tactile feedback, and/or gesture with an arm that is wearing the wristband electronic device.

An arm gesture is used to activate the accelerometer and/or gyroscopic sensors that sense the movement as well as a direction of movement along multiple axes of the electronic device. The movement detection as well as direction of movement may both be used to activate different functions. The gesture movement/direction and associated function may be controlled with a user setting. Gestures might include a user moving their arm outwards, shaking the wrist to which the electronic device is attached, moving their arm up and down or moving their arm side-to-side. Each gesture may be detected by the sensors of the electronic device and used in different ways.

For example, one gesture may instruct the device to indicate the electronic device status on the display. Another gesture may instruct the device to show the current time. Yet another gesture may instruct the device to respond with a predetermined response to a textual message (e.g., text message, email) that is currently being displayed. Each of these gestures may have different meanings depending on the present function being implemented and/or the current icon(s) being displayed (e.g., the location within the menu system). In an embodiment, the gesture activates a function associated with an already selected icon of the menu system. In an embodiment, the gesture may select an icon from the icons in the display of the electronic device. Yet another embodiment may both select the icon and activate the function in response to one or more movements of the electronic device.

The menu system of the electronic device additionally provides the user with the ability to use icons, iconic menus, and alphanumeric characters to create simple, stored messages without typing or using a keyboard. These stored messages may then be implemented using the gestures just described or another icon of the menu system.

If the wearable electronic device 100 is implemented in a wristband or other wearable electronic device, a haptic sensation (e.g., vibration) can alert the user to a particular situation such as an appointment reminder or incoming text/call. The user may then respond with an arm gesture that is sensed by the accelerometer and/or gyroscopic sensors. The response associated with the arm gesture may depend on the gesture and the particular situation that prompted the response. In other words, a different response (e.g., a different stored message) may be transmitted in response to a predetermined arm gesture or movement of the electronic device. For example, a movement in one direction might transmit a stored response textual message stating that the user will return the sender's call. A movement in another direction might transmit another stored message that the user is unavailable at this time. These movements can be trained into the electronic device by the user.

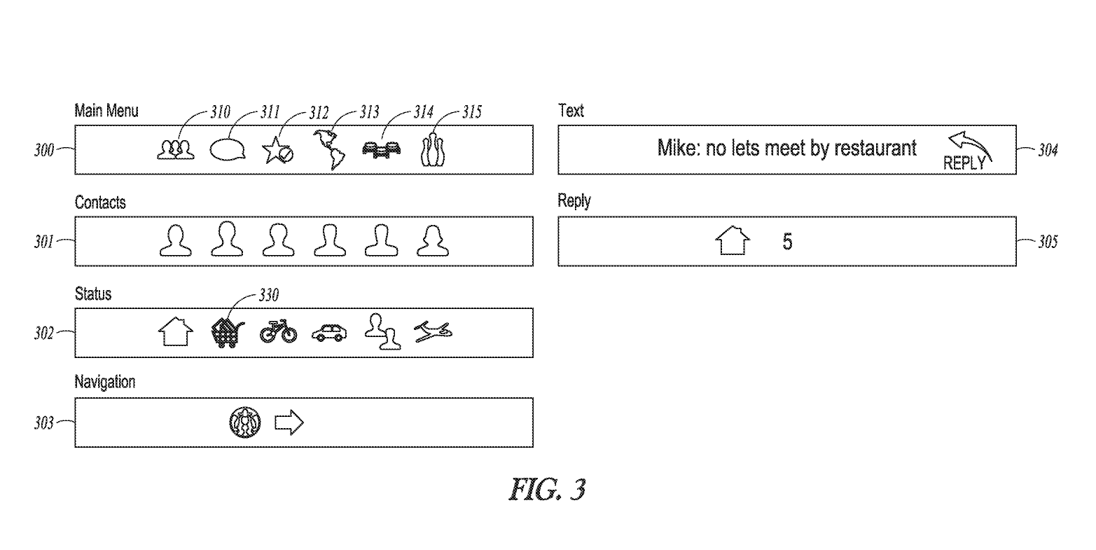

FIG. 3 illustrates an embodiment of different menus and submenus displayable on the electronic device. This figure illustrates a diagram of a plurality of different menus 300-305 that may appear on the display of the electronic device. In FIG. 3, the menus 300-305 include a main menu 300 and a number of submenus 301-305 that are activated in response to selection of an icon on the main menu 300.

The main menu 300 can include a contact information list icon 310, a text messaging function icon 311, a status function icon 312, a navigation function icon 313, a reply function icon 314, and a graphics function icon 315. These icons 310-315 and associated functions are for purposes of illustration only as the electronic device menu system can include numerous other icons and functions.

The main menu 300 can contain the highest level icons. These icons can be user selectable as well as user definable. In other words, the user can select from a plurality of different icons to represent a particular function. The user can then assign that icon to activate the desired function when it is selected (e.g., touched) on the touchscreen display.

As an example of operation, selection of the contact information list icon 310 can display a submenu 301 of different contacts in the users contact database. The icons in the submenu 301 can be images or names, or combinations of images and names, of each contact in the contact database. The user can then select the desired contact by touching the particular icon assigned to that contact to access various functions, including but not limited to placing a call to the contact on a mobile telephone that is coupled to the electronic device, displaying a listing of the contact information, or initiating a communication using other modes of operation (e.g., short message service texting).

Selection of the text messaging function icon 311 can display a submenu 304 of a texting function. The submenu 304 can then display different stored text messages that the user can send by touching a reply icon on the display or by gesturing with the wrist having the wearable electronic device. The accelerometer/gyroscopic sensor would then detect the gesture and take an appropriate action. The same gesturing can also be used to scroll between different stored replies until the desired reply is displayed, accepted, and transmitted by the just described icon or gesturing.

Selection of the status function icon 312 can display a submenu 302 of a number of user statuses. The status submenu 302 can provide the user with the ability to select one of the statuses presented to people trying to contact the user. For example, if the user selected the shopping cart icon 330, the user's partner could see that the user was at the grocery store and that this might be a good time to inform the user to pick up an additional item at the store. In an alternate embodiment, a GPS sensor in the electronic device might detect the user's location and, using those geographical coordinates, determine that the user was at a grocery store. This information could then be transmitted to selected parties as set by the user in a setting database.

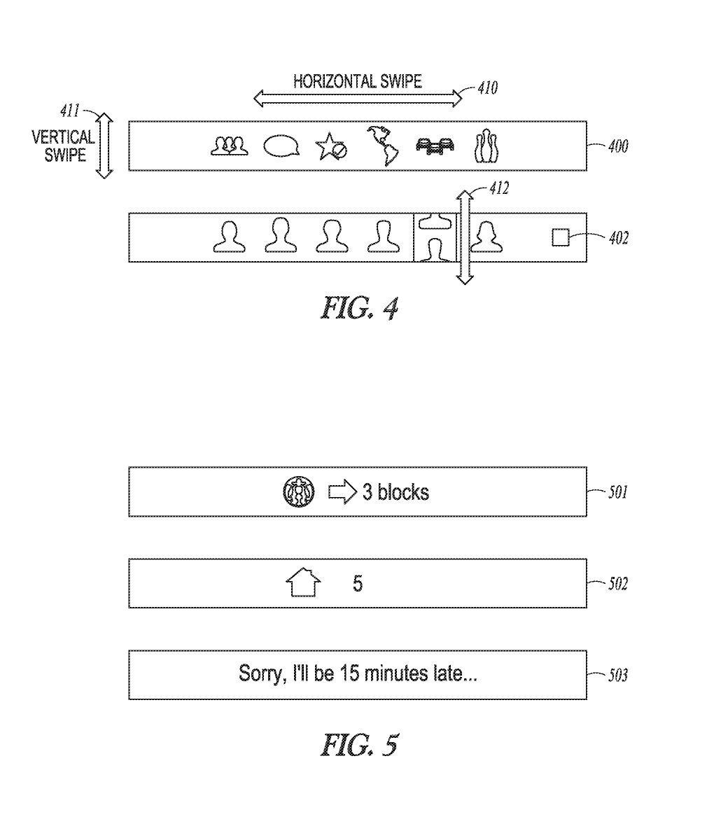

FIG. 4 illustrates an embodiment for various possible interactions for navigating through the menus of the electronic device. The interactions of FIG. 4 are for purposes of illustration only as the menu system in the electronic device is not limited to any one interaction.

A main menu 400 is shown with different possible touchscreen inputs for interacting with the menu system. For example, a horizontal swipe 410 with a finger across the display could be used to move the icons in the display to the left or right along the display. A vertical swipe 411 with a finger across the display could be used to move the icons up and down on the display. Touching one icon 402 with one digit (e.g., thumb) while simultaneously swiping vertically 412 may be used to scroll through multiple icons/images in one location of the display.

FIG. 5 illustrates multiple embodiments of messages that may appear on the display of the electronic device. For example, one status message 501 might indicate a distance to a desired location (e.g., 3 blocks to coffee shop). In the stand-alone mode embodiment, a GPS sensor in the electronic device could be used to determine this distance if the destination is known. In the companion mode embodiment, the electronic device may receive data over a radio link (e.g., BLUETOOTH™, WI-FI™) that indicates a desired destination and distance to the destination to be displayed on the electronic device.

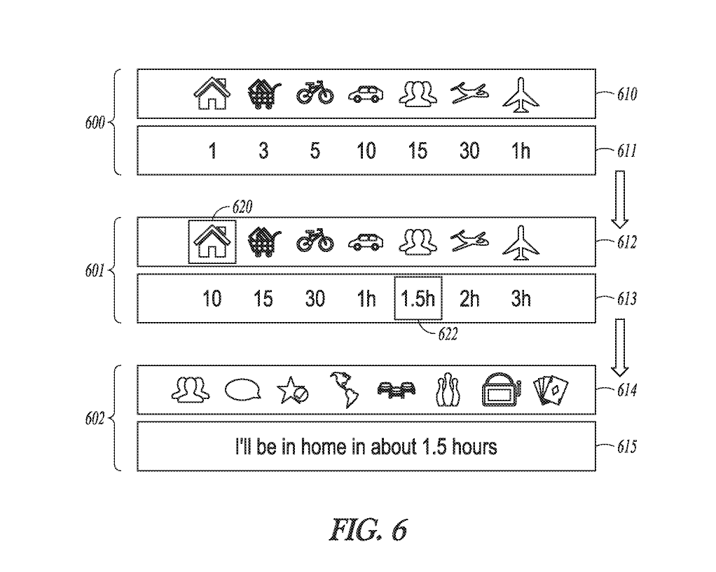

Another status message 502 might indicate, using icons, a time to another location (e.g., 5 minutes to home). The user may then use these icons, as described subsequently with reference to FIG. 6, to generate a message to be transmitted.

Yet another status message 503 might indicate a stored response to be transmitted. If the electronic device is aware, through an internal GPS sensor or another coupled electronic device with GPS, of when the user will be arriving at the desired destination, the system of the electronic device may compare that time to the originally selected time to arrive. The menu system, of the electronic device may then generate such a status message 503 using contextual intelligence, thus enabling the user to transmit this message with minimal user input.

FIG. 6 illustrates an embodiment for generating messages on the electronic device using an iconic menu entry method. The illustrated embodiment includes a display that is wide enough to accommodate two rows of icons. An alternate embodiment CAN accomplish this method using only one row that may alternate between different icons/characters.

The top display 600 shows a row of status icons 610 and a second row of time characters 611. The user may use the swipe mechanism previously-described to display additional icons or characters as necessary to generate the desired message.

FIG. 6 shows that the user has selected the home icon 620 in the top row 612 and the time character of 1.5 hours 622 in the bottom row 613 of the second display 601. These inputs 620, 622 are used by the menu system in the electronic device to generate a message to be transmitted.

The bottom row 615 of the bottom display 602 shows the textual message that was generated and transmitted. This message enables the receiving person to understand the message without having to decipher the iconic language. The bottom display 602 also shows that the top row 614 has automatically changed back to the main menu after message transmission without additional inputs from the user.

The method illustrated in FIG. 6 may also be used for generating textual messages for storage in the electronic device. These stored messages may be selected later based on an input from the user such as an icon selection or a gesture performed by the user wearing the electronic device. The selected message may then be transmitted to another electronic device for display.

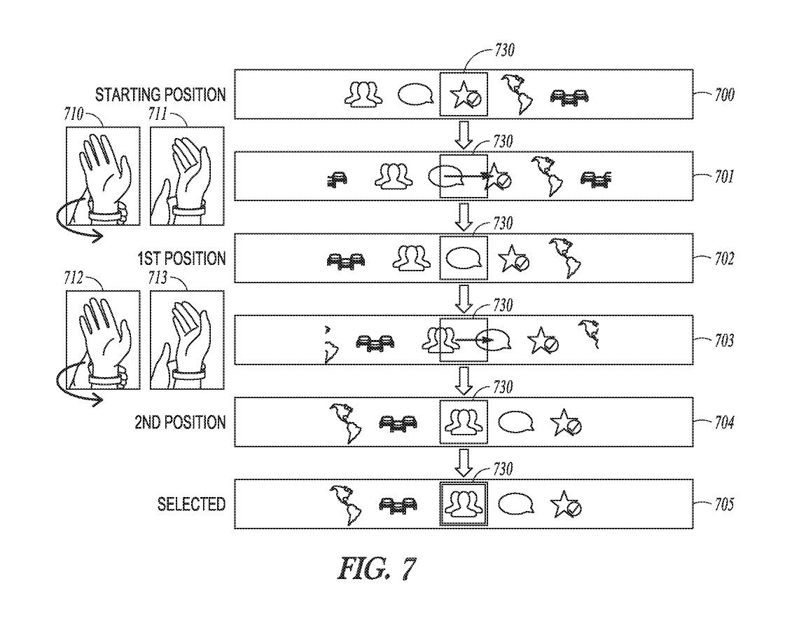

FIG. 7 illustrates an embodiment for interacting with the menu system of the electronic device using gestures. This embodiment enables the user to input commands without looking at the display. For example, while the user is running with a wearable wristband electronic device, the user may simply perform this embodiment to input a desired command.

The display is initially at the default main menu display 700. A cursor 730 is currently selecting a status icon in the first display 700 (e.g., main menu). The user may then move the cursor, as shown going from first display 700 to the second display 701, by grasping the wristband electronic device 710 and twisting in a predetermined direction (e.g., counter-clockwise). This results in the wristband ending in a first position 711 and the cursor 730 moving to select the texting icon in the third display 702. If this is the desired icon of the menu system to select, the user is done.

If the user desires to continue moving the cursor 730 to another icon, the same procedure may be used. The user grasps the wristband 712 and twists once more in the counter-clockwise direction to a second position 713. This has the effect of moving the cursor as shown going from the fourth display 703 to the fifth display 704. The cursor 730 is now over the contact icon in the fifth display 704. Assuming that this is the desired icon to be selected, the function represented by the selected icon is activated after a predetermine time period has expired (e.g., 1 second). This is shown in the final display 705. The cursor 730 may change to another color to indicate that the function has been selected just prior to the function being activated.

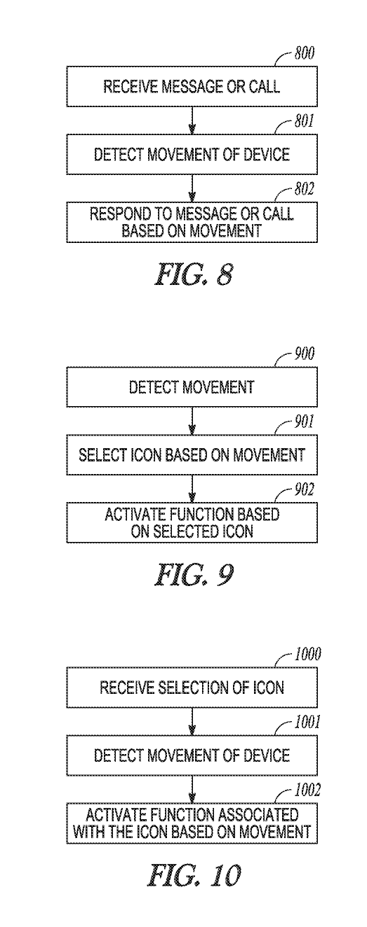

FIG. 8 illustrates a flowchart of one embodiment of an iconic menu system interaction. A textual message or telephone call 800 is received. The electronic device then detects a user movement (e.g., gesture, axial twisting) 801. The electronic device then responds to the textual message or call based on the detected movement 802.

FIG. 9 illustrates a flowchart of another embodiment of an iconic menu system, interaction. A user movement of the electronic device 900 is detected. An icon of the electronic device is selected based on the user movement 901. A function of the electronic device is activated based on the selected icon 902.

FIG. 10 illustrates a flowchart of another embodiment of an iconic menu system interaction. An icon selection is received from a user 1000. A movement of the electronic device is detected 1001. A function of the electronic device that is associated with the selected icon is activated based on the detected movement of the electronic device 1002.

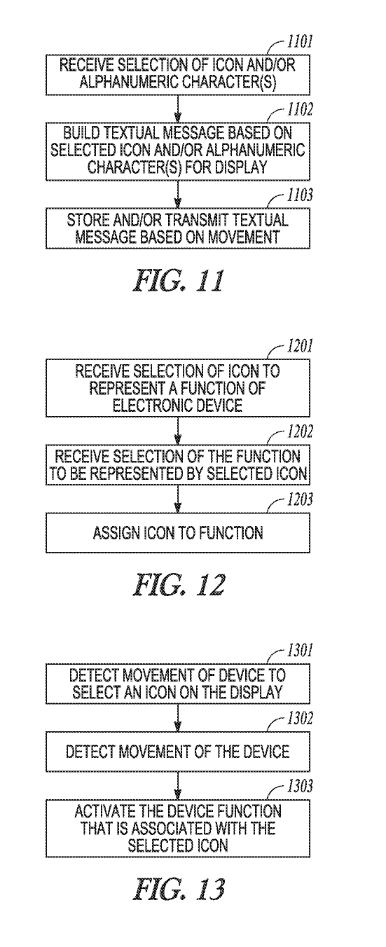

FIG. 11 illustrates a flowchart of another embodiment of an iconic menu system interaction. A selection of an icon and/or alphanumeric characters 1101 is received from a user. The electronic device then builds a textual message based on the user selected icon and/or characters for display on the device 1102, The textual message may then be stored and/or transmitted 1103. In one embodiment, the storing and/or transmitting is based on a user movement of the electronic device.

FIG. 12 illustrates a flowchart of another embodiment of an iconic menu system interaction. A selection of an icon is received from a user to represent a function of the electronic device 1201. The function to be represented by the selected icon is received from the user 1202. The function is assigned to the icon 1203.

FIG. 13 illustrates a flowchart of another embodiment of an iconic menu system interaction. A user movement of the device is received to select an icon on the display of the electronic device 1301. The movement direction is detected 1302. A function of the electronic device that is associated with the selected icon is activated 1303.

### Additional Notes and Examples:

Example 1 is an electronic device that has a controller configured to execute an iconic menu system of the electronic device, a display, coupled to the controller, configured to display icons generated by the controller, a plurality of sensors, coupled to the controller, configured to detect a movement of the electronic device, and memory coupled to the controller, wherein the controller is further configured to execute a selected one of a plurality of functions in response to the movement, the function being associated with a selected icon of the iconic menu system.

In example 2, the subject matter of Example 1 can optionally include wherein the electronic device configured as a wristband device.

In example 3, the subject matter of any one of Examples 1-2 can optionally include wherein the display comprises one of: a liquid crystal display (LCD), an organic light emitting diode display (OLED), a plasma display, or electronic ink (e-ink).

In example 4, the subject matter of any one of Examples 1-3 can optionally include wherein the display is a touch sensitive display.

In example 5, the subject matter of any one of Examples 1-4 can optionally include a radio transceiver coupled to the controller.

In example 6, the subject matter of any one of Examples 1-5 can optionally include wherein the transceiver is configured to transmit and receive using a communication standard selected from: Bluetooth, GSM, TDMA, CDMA, and/or Wi-Fi.

In example 7, the subject matter of any one of Examples 1-6 can optionally include wherein the memory is read only memory, non-volatile memory-, static random access memory, and/or dynamic random access memory.

In example 8, the subject matter of any one of Examples 1-7 can optionally include wherein the controller is further configured to select the icon in response to the movement.

In example 9, the subject matter of any one of Examples 1-8 can optionally include wherein the plurality of sensors comprise: an accelerometer, a solid state gyroscopic sensor, a light sensor, a global positioning system receiver, a temperature sensor, and/or a barometric sensor.

In example 10, the subject matter of any one of Examples 1-9 can optionally include a haptic sensation output coupled to the controller.

In example 11, the subject matter of any one of Examples 1-10 can optionally include an aural input and an aural output.

In example 12, the subject matter of any one of Examples 1-11 can optionally include wherein the controller is further configured to communicate with another electronic device over a radio link.

Example 13 is a method for menu system interaction in an electronic device, the method can comprise selecting an icon of the menu system in response to a user movement of the electronic device and activating a function of the electronic device associated with the icon.

In example 14, the subject matter of Example 13 can optionally include wherein selecting the icon of the menu system comprises selecting one of a plurality of icons of the menu system in response to a direction of user movement of the electronic device.

In example 15, the subject matter of any one of Examples 13-14 can optionally include wherein activating the function comprises activating the function in response to the user movement of the electronic device.

In example 16, the subject matter of any one of Examples 13-15 can optionally include wherein activating the function in response to the movement of the electronic device comprises activating the function in response to the direction of the user movement of the electronic device.

In example 17, the subject matter of any one of Examples 13-16 can optionally include wherein activating the function comprises transmitting a textual message in response to the user movement.

In example 18, the subject matter of any one of Examples 13-17 can optionally include wherein transmitting the textual message comprises transmitting the textual message that is displayed on a display of the electronic device.

In example 19, the subject matter of any one of Examples 13-18 can optionally include sensing the movement of the electronic device by one of: an accelerometer sensor or a gyroscopic sensor.

Example 20 is a method for menu system interaction in an electronic device that comprises receiving from a user a selection of an icon of the menu system, detecting the user movement of the electronic device, and activating a function of the electronic device, associated with the icon, in response to the user movement of the electronic device.

In example 21, the subject matter of Example 20 can optionally include wherein activating the function comprises activating a time indication on the display of the electronic device.

In example 22, the subject matter of any one of Examples 20-21 can optionally include wherein activating the function comprises activating a status on the display of the electronic device.

In example 23, the subject matter of any one of Examples 20-22 can optionally include wherein the status is a status of a device coupled to the electronic device over a radio link.

Example 24 is a method for menu system interaction in an electronic device that comprises receiving from a user a selection of an icon of the menu system, and building a textual message in response to the selected icon for display on the electronic device.

In example 25, the subject matter of Example 24 can optionally include storing the textual message in a memory of the electronic device.

In example 26, the subject matter of any one of Examples 24-25 can optionally include transmitting the textual message in response to a user movement of the electronic device.

In example 27, the subject matter of any one of Examples 24-26 can optionally include selecting the icon and a plurality of associated alphanumeric characters.

In example 28, the subject matter of any one of Examples 24-27 can optionally include storing the textual message in the electronic device, sensing a user movement of the electronic device, and transmitting the textual message in response to the user movement of the electronic device.

In example 29, the subject matter of any one of Examples 24-28 can optionally include determining geographical coordinates for the electronic device and selecting one of a plurality of messages for transmitting by the electronic device in response to the geographical coordinates.

In example 30, the subject matter of any one of Examples 24-29 can optionally include building the textual message in response to the geographical coordinates of the electronic device.

Example 31 is a method for menu system interaction in an electronic device that comprises receiving a user selection of one of a plurality of icons to represent a function of the electronic device, and assigning the user selected icon to represent the predetermined function wherein receiving a further selection of the icon activates the function.

In example 32, the subject matter of any one of Example 31 can optionally include receiving a user selection of the function of a plurality of functions of the electronic system to be represented by the user selected icon.

In example 33, the subject matter of any one of Examples 31-32 can optionally include receiving a swipe of a display of the electronic device in one of a plurality of directions.

In example 34, the subject matter of any one of Examples 31-33 can optionally include receiving the swipe of the display of the electronic device in a vertical direction.

Example 35 is a method for menu system interaction in an electronic device that comprises receiving one of a textual message or a telephone call on the electronic device, detecting a user movement of the electronic device, and responding to the textual message or the telephone call in response to the user movement of the electronic device.

In example 36, the subject matter of Example 35 can optionally include wherein responding to the textual message or the telephone call comprises transmitting a different stored message in response to detecting the direction of user movement of the electronic device.

Example 37 is method for menu system interaction in a wristband electronic device that comprises receiving a user movement of the wristband electronic device in a first direction to select an icon on a display of the wristband electronic device, detecting the user movement of the wristband electronic device, and activating a function of the wristband electronic device associated with the selected icon in response to expiration of a predetermined time period.

In example 38, the subject matter of Example 37 can optionally include wherein the predetermined icon on the display is selected by a cursor substantially surrounding the icon on the display.

In example 39, the subject matter of any one of Examples 37-38 can optionally include wherein the cursor moves in response to detecting the user movement of the wristband electronic device.

In example 40, the subject matter of any one of Examples 37-39 can optionally include wherein a direction of movement of the cursor on the display is different in response to the user movement of the wristband electronic device in either the first direction or a second direction.

Example 41 is an electronic device comprising means for displaying a plurality of icons of a menu system, means for detecting a movement of the electronic device, means for selecting a first icon of the plurality of icons in response to the movement of the electronic device, and means for activating a function of the electronic device associated with the icon.

In example 42, the subject matter of Example 41 can optionally include means for transmitting a textual message in response to the movement.

In example 43, the subject matter of any one of Examples 41-42 can optionally include comprising means for receiving a textual message.

In example 44, the subject matter of any one of Examples 41-43 can optionally include means for coupling the electronic device to another electronic device over a radio link.

In example 45, the subject matter of any one of Examples 41-44 can optionally include comprising means for receiving an aural input.

In example 46, the subject matter of any one of Examples 41-45 can optionally include comprising means transmitting a haptic sensation.

In example 47, the subject matter of any one of Examples 41-46 can optionally include comprising means for storing messages.

In example 48, the subject matter of Example 41 can optionally include the electronic device being a wearable electronic device.

In example 49, the subject matter of Example 41 can optionally include the electronic device being a user wearable wristband.

In example 50, the subject matter of Example 41 can optionally include a touch sensitive area that is away from and adjacent to the plurality of icons.

In example 51, the subject matter of Example 41 can optionally include means for sensing one or more of conditions, movement, current location of the electronic device, temperature, ambient pressure, galvanic skin response, blood circulation, and/or electro-encephalographic (EEG) data.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In tins document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary- skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. (canceled)

2. At least one non-transitory machine readable medium for menu system interaction in an electronic device comprising a plurality of instructions that, in response to being executed by a controller, cause the electronic device to:
receive, on the touch sensitive display, a user selection of one of a plurality of icons to represent a predetermined function of the electronic device; and
assign the user selected icon to represent the predetermined function wherein further selection of the icon on the touch sensitive display activates the predetermined function.

3. The at least one non-transitory machine readable medium of claim 2 wherein the instruction to receive the user selection of one of the plurality of icons causes the electronic device to receive a swipe of a display of the electronic device in one of a plurality of directions.

4. The at least one non-transitory machine readable medium of claim 2 and further comprising an instruction to cause the electronic device to transmit a textual message in response to a user movement of the electronic device.

5. The at least one non-transitory machine readable medium of claim 2 wherein the plurality of instructions further cause the electronic device to select one of the plurality of icons in response to a direction of user movement of the electronic device.

6. The at least one non-transitory machine readable medium of claim 2 wherein the plurality of instructions further respond to a textual message or a telephone call with a transmission of a different stored message in response to detecting the direction of user movement of the electronic device.

7. The at least one non-transitory machine readable medium of claim 2 wherein a user selection of one of the plurality of icons comprises receiving a swipe of a display of the electronic device in one of a plurality of directions.

8. The at least one non-transitory machine readable medium of claim 2 wherein the plurality of instructions further build a textual message in response to the geographical coordinates of the electronic device.

9. The at least one non-transitory machine readable medium of claim 2 wherein the plurality of instructions further:
determine geographical coordinates for the electronic device; and
select one of a plurality of messages for transmitting by the electronic device in response to the geographical coordinates.

10. The at least one non-transitory machine readable medium of claim 2 wherein the plurality of instructions further:
receive one of a textual message or a telephone call on the electronic device;
detect a user movement of the electronic device; and
respond to the textual message or the telephone call with a transmitted response in response to the user movement of the electronic device.

11. The at least one non-transitory machine readable medium of claim 10 wherein the instruction causing the electronic device to respond to the textual message or the telephone call causes the electronic system to transmit a different stored message in response to detecting the direction of user movement of the electronic device.

12. A method for menu system interaction in a wristband electronic device, the method comprising:
receiving a user movement of the wristband electronic device in a first direction;
detecting the user movement of the wristband electronic device to select an icon on a display of the wristband electronic device; and
activating a function of the wristband electronic device associated with the selected icon in response to expiration of a predetermined time period.

13. The method of claim 12 wherein the selected icon on the display is selected by a cursor substantially surrounding the icon on the display.

14. The method of claim 12, further comprising building a textual message in response to the geographical coordinates of the electronic device.

15. A method for menu system interaction in a wearable electronic device having a touch sensitive display, the method comprising:
receiving, on the touch sensitive display, a user selection of one of a plurality of icons to represent a predetermined function of the electronic device; and
assigning the user selected icon to represent the predetermined function wherein further selection of the icon on the touch sensitive display activates the predetermined function.

16. The method of claim 15 wherein activating the predetermined function comprises activating a time indication on the display of the electronic device.

17. The method of claim 15 wherein activating the predetermined function comprises activating a status on the display of the electronic device.

18. The method of claim 17 wherein the status is a status of a device coupled to the electronic device over a radio link.

19. The method of claim 15 and further comprising receiving a user selection of the predetermined function of a plurality of functions of the electronic device to be represented by the user selected icon.

20. The method of claim 15 wherein receiving the user selection of one of the plurality of icons comprises receiving a swipe of a display of the electronic device in one of a plurality of directions.

21. The method of claim 20 wherein receiving the swipe of the display of the electronic device comprises receiving a swipe of the display in a vertical direction.
